(19) United States
(12) Patent Application Publication
(10) Pub. No.: US 2004/0178274 A1
(43) Pub. Date: Sep. 16, 2004

(54) Contactless radio frequency magnetic field data transmission card and its application system

(76) Inventors: Chang-Ta Wu, Jubei City (TW); Chun-Ping Lin, Hsinchu (TW)

Correspondence Address: J.C. Patents, Inc., Suite 250, 4 Venture, Irvine, CA, 92618, US

(21) Appl. No.: 10/629,152

(22) Filed: Jul. 28, 2003

Related U.S. Application Data
(60) Provisional application No. 60/454,974, filed on Mar. 14, 2003.

(30) Foreign Application Priority Data
Apr. 23, 2003 (TW) 92109452

(51) Int. Cl. G06K 19/06

(52) U.S. Cl. 235/491; 455/41.1; 455/41.2

(57) ABSTRACT

A contactless radio frequency magnetic field data transmission card and its application system are provided. A magnetic field identification chip, a micro processing unit and an antenna module are combined to constructed a contactless radio frequency magnetic field data transmission card, so that messages can be communicated with a radio frequency magnetic field identification reader according to a transmission protocol. Applications can be very wide for use in such as an e-card or an e-purse.

### CROSS-REFERENCE TO RELATED APPLICATION

This application claims the priority benefit of U.S.A. provisional application serial No. 60/454,974, filed on Mar. 14, 2003, all disclosures are incorporated therewith. This application also claims the priority of Taiwan application serial no. 92109452, filed Apr. 23, 2003.

### BACKGROUND OF THE INVENTION

1.Field of the Invention

The present invention relates in general to a contactless data transmission. More particularly, the present invention relates to a contactless radio frequency magnetic field data transmission card and its application system.

2. Description of Related Art

In a conventional safety identification system, a contact data transmission is usually used to read a personal identification for safety. However, the contact data transmission has following drawbacks. First, it needs a long time in an operation process. Taking a financial card transaction process of a financial system as an example, because processes such as a card guiding, a card transporting, and a magnetic bar reading, etc. have to be executed, a lot of waiting time is wasted. Furthermore, because all contents of the contact data transmission card is stored in the magnetic bar on the back side of the contact data transmission card, all the stored contents might completely disappeared if the card is demagnetized because the card is near a magnetic body, so that the card is not very reliable.

Therefore, a password identification card using a magnetic field transmission and a radio frequency magnetic field identification reader (RF MFID reader) is developed. Although this password identification card uses a contactless transmission, the identification password can be still read or written. Related programs for interaction are stored in RF MFID reader. Therefore, a real time message communication cannot be set as required, and thus, its application is limited.

### SUMMARY OF THE INVENTION

According to the foregoing description, an object of this invention is to provide a contactless radio frequency magnetic field data transmission card and its application system, which can communicate message in real time according to a transmission protocol. Thus, the overall application becomes wider.

According to the object mentioned above, a contactless radio frequency magnetic field data transmission system is provided. The contactless radio frequency magnetic field data transmission system comprises a radio frequency magnetic identification reader having a magnetic identification chip for transceiving a magnetic field signal; and a contactless radio frequency magnetic field data transmission card, having a magnetic identification chip for transceiving the magnetic field signal. A message is transmitted between the radio frequency magnetic identification reader and the contactless radio frequency magnetic field data transmission card according to a transmission protocol.

The magnetic field identification chip is used for converting the message into a magnetic field signal and then transmitting the magnetic field signal through the antenna module, and converting a magnetic field signal received by the antenna module into the message.

The micro processing unit comprises a micro controller and a liquid crystal display for communicating messages in real time according to the predetermined transmission protocol. Also, the micro processing unit further comprises an input peripheral so that a user can input instructions.

In one aspect of the present invention, the magnetic field identification chip can be a W55MID50 chip, manufactured by Winbond Electronics Corporation.

The contactless radio frequency magnetic field data transmission card is an e-card, or an e-purse.

A package according to the transmission protocol comprises a 4-bit package header, a 4-bit code, a message string with a length dependent on the 4-bit code.

Accordingly, as described above, the contactless radio frequency magnetic field data transmission card and its application system of the present invention can communicate messages in real time according to the predetermined transmission protocol. In this way, the disclosure of the present invention is applicable to display data for the e-card or the e-purse, etc., to edit, or other additional functions. Therefore, the present invention can be widely used.

### BRIEF DESCRIPTION OF THE DRAWINGS

While the specification concludes with claims particularly pointing out and distinctly claiming the subject matter which is regarded as the invention, the objects and features of the invention and further objects, features and advantages thereof will be better understood from the following description taken in connection with the accompanying drawings.

FIG. 1 schematically shows a system block diagram of an application system of a contactless radio frequency magnetic field data transmission card.

FIG. 2 shows a timing diagram for data transmission according to the embodiment of the invention.

FIG. 3 is an exemplary package format according to the embodiment of the invention.

FIG. 4 is an exemplary package structure according to the embodiment of the invention.

### DESCRIPTION OF THE PREFERRED EMBODIMENT

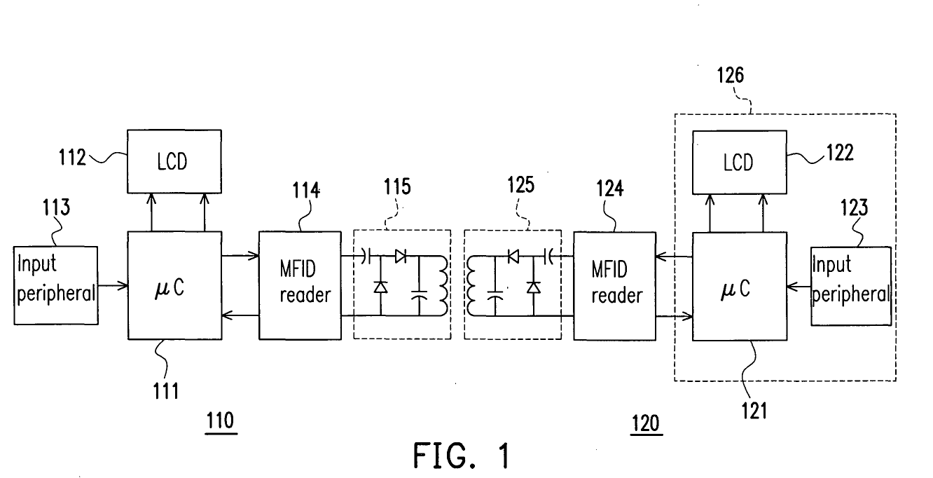

FIG. 1 schematically shows a system block diagram of an application system of a contactless radio frequency magnetic field data transmission card according to one embodiment of the present invention. Referring to FIG. 1, the application system of the contactless radio frequency magnetic field data transmission card comprises a radio frequency magnetic field identification reader (RF MFID reader) 110 and a contactless radio frequency magnetic field data transmission card 120. The RF magnetic field data transmission card 120 can be, for example, a personally portable E-purse or e-business card. The RF MFID reader 110 can be a service host established at a bank side or other locations, which is able to communicate with the contactless radio frequency magnetic field data transmission card 120 (such as the e-purse or the e-business card, etc.) based on a predetermined protocol. When the contactless radio frequency magnetic field data transmission card 120 is an e-business card, a communication between two e-business cards can be established to exchange the e-business cards in any time.

In FIG. 1, the RF MFID reader 110 comprises a micro controller 111, a liquid crystal display (LCD) 112, an input peripheral 113, a magnetic field identification chip 114 and an antenna module 115. The contactless RF magnetic field data transmission card 120 comprises a micro controller 121, a micro processing unit for a LCD 122 and an input peripheral 123, a magnetic field identification chip 124, and an antenna module 125.

The micro controllers 111, 121 can comprises a LCD controller (not shown) respectively for driving the LCD 112, 122 to display. In the present embodiment, the magnetic field identification chips 114, 124 use a W55MID50 chip, manufactured and designed by Winbond Electronics Corporation. In addition to serving as a general RF MFID reader that can only read or write an identification code, the W55MID50 chip also provide an operation mode that the micro processing unit 126 can control a message communication. The input peripheral 113 can be a keyboard, and the input peripheral 123 can be a keypad. To those skilled in this art, when the contactless RF magnetic field data transmission card 120 is an e-purse, the input peripheral 123, such as the keypad, can be omitted to minimize the space occupied by the contactless RF magnetic field data transmission card 120.

The function of the magnetic field identification chips 114, 124 is used to convert messages to be transmitted into magnetic field signals, and then the magnetic field signal is respectively transmitted through the antenna modules 115 and 125. Also, the antenna modules 115 and 125 receives the magnetic field signals into the messages, so that the micro controllers 111 and 121 can transmit or receive messages according to a predetermined transmission protocol.

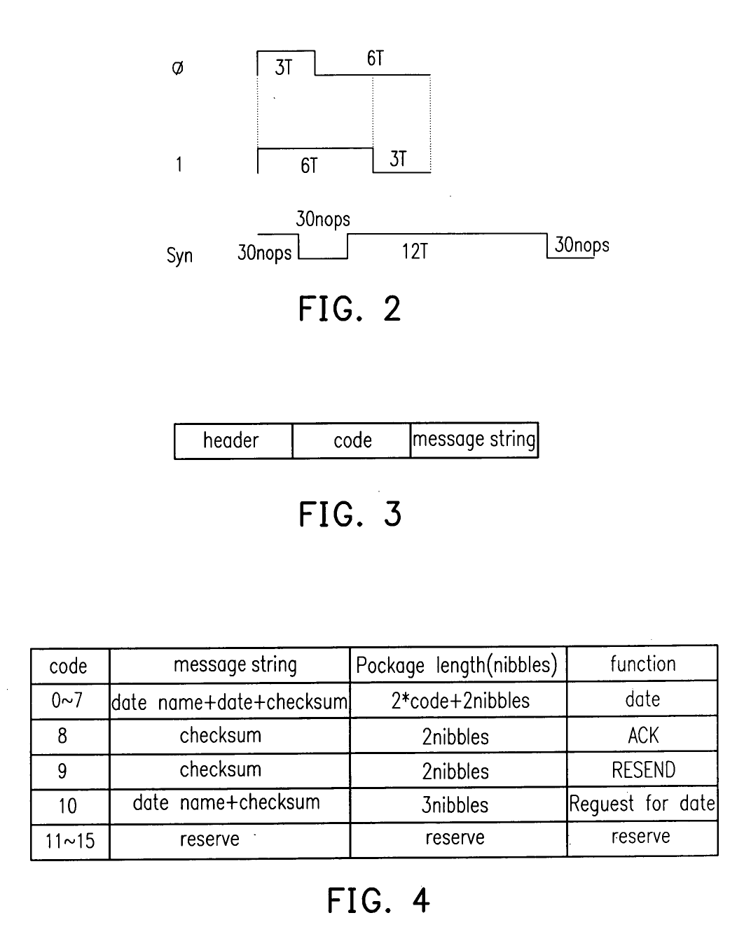

FIGS. 2, 3 and 4 illustrate and exemplary format for the transmission protocol used in the embodiment of the present invention. FIG. 2 shows a timing diagram when signals are transmitted. FIG. 3 shows a package format and FIG. 4 shows a package structure. As shown in FIG. 2, assuming that a sampling period at a receiving side is T, this invention defines that a high level signal of 3T has to be transmitted first when transmitting data 0 and then a low level signal of 6T is followed. When transmitting data 1, a high level signal of 6T is transmitted first, and then a low level signal of 3T is transmitted. In addition, each time before data is transmitted, a high level signal with a width of 30 nops (no operation instructions) has to be transmitted first, followings are a low level signal with a width of 30 nops and a high level signal of 12T, and then a low level synchronous signal Sync with a width of 30 nops is transmitted. In this way, the receiving side can thus restore received data according to condition of sampling received data.

Referring to FIGS. 3 and 4, in FIG. 3 a format of a transmitted package comprises a 4-bit package header, a 4-bit code, and a message string with a length based on the 4-bit code. A package structure with different codes are defined as shown in FIG. 4. The codes 0 to 7 are used to transmit codes with different data lengths, and the message string can comprise fields, such as data name, data, and checksum, etc. The data name and checksum fields have a width of one nibble respectively, and the package length is (2×code+2) nibbles. The code 8 is an acknowledge code; therefore, the corresponding message string comprises the checksum field only, and the package length is 2 nibbles, including the code and the checksum fields. The code 9 is a code used to request resending data; therefore, the corresponding message string also comprises the checksum field only, and the package length is 2 nibbles, including the code and the checksum fields. The code 10 is a code for requesting data; therefore, the corresponding message string comprises the data name and the checksum fields, and the package length is 3 nibbles, including the code, the data name and the checksum fields.

The codes 11 to 15 are reserved for other expansion functions. The data name field uses 0, 1, and 2, for example, to specify data, such as a name, a password and an amount, respectively. Therefore, programs executed in the micro controllers 111 and 121 of both the receiving side and the transmitting side can transmit and receive messages in a contactless way according to the aforementioned codes and transmission protocol.

In summary, the present invention provides a contactless RF magnetic field data transmission card and its application system, which is applicable to display data for the e-card or the e-purse, etc., to edit, or other additional functions. Therefore, the present invention can be widely used.

While the present invention has been described with a preferred embodiment, this description is not intended to limit our invention. Various modifications of the embodiment will be apparent to those skilled in the art. It is therefore contemplated that the appended claims will cover any such modifications or embodiments as fall within the true scope of the invention.

What is claimed is:

1. A contactless radio frequency magnetic field data transmission card, for transceiving a message with a radio frequency (RF) magnetic field identification reader, comprising:
an antenna module;
a micro processing unit for transceiving the message according to a transmission protocol; and
a magnetic field identification chip, coupled to the antenna module and the micro processing unit, for converting the message into a magnetic field signal and then transmitting the magnetic field signal through the antenna module, and converting a magnetic field signal received by the antenna module into the message.

2. The contactless radio frequency magnetic field data transmission card of claim 1, wherein the micro processing unit comprises a micro controller and a liquid crystal display.

3. The contactless radio frequency magnetic field data transmission card of claim 2, wherein the micro processing unit further comprises an input peripheral.

4. The contactless radio frequency magnetic field data transmission card of claim 1, wherein a package according to the transmission protocol comprises a 4-bit package header, a 4-bit code, a message string with a length dependent on the 4-bit code.

5. The contactless radio frequency magnetic field data transmission card of claim 1, wherein the magnetic field identification chip is a W55MID50 chip, manufactured by Winbond Electronics Corporation.

6. The contactless radio frequency magnetic field data transmission card of claim 1, wherein the contactless radio frequency magnetic field data transmission card is used as an e-purse.

7. The contactless radio frequency magnetic field data transmission card of claim 1, wherein the contactless radio frequency magnetic field data transmission card is used as an e-card.

8. A contactless radio frequency magnetic field data transmission system, comprising:
a radio frequency magnetic identification reader, having a magnetic identification chip for transceiving a magnetic field signal; and
a contactless radio frequency magnetic field data transmission card, having a magnetic identification chip for transceiving the magnetic field signal,
wherein a message is transmitted between the radio frequency magnetic identification reader and the contactless radio frequency magnetic field data transmission card according to a transmission protocol.

9. The contactless radio frequency magnetic field data transmission system of claim 8, wherein the contactless radio frequency magnetic field data transmission card further comprises an antenna module and a micro processing unit.

10. The contactless radio frequency magnetic field data transmission system of claim 9, wherein the micro processing unit comprises a micro controller and a liquid crystal display.

11. The contactless radio frequency magnetic field data transmission system of claim 10, wherein the micro processing unit further comprises an input peripheral.

12. The contactless radio frequency magnetic field data transmission system of claim 8, wherein the magnetic field identification chip is a W55MID50 chip, manufactured by Winbond Electronics Corporation.

13. The contactless radio frequency magnetic field data transmission system of claim 8, wherein the contactless radio frequency magnetic field data transmission card is an e-card.

14. The contactless radio frequency magnetic field data transmission system of claim 8, wherein the contactless radio frequency magnetic field data transmission card is an e-purse.

15. The contactless radio frequency magnetic field data transmission system of claim 8, wherein the radio frequency magnetic identification reader is an e-card.

16. The contactless radio frequency magnetic field data transmission system of claim 8, wherein the a package according to the transmission protocol comprises a 4-bit package header, a 4-bit code, a message string with a length dependent on the 4-bit code.
